(19) United States
(12) Patent Application Publication
(10) Pub. No.: US 2004/0095755 A1
(43) Pub. Date: May 20, 2004

(54) Flashlight having two sets of bulbs

(76) Inventor: Chih-Ching Hsien, Taichung (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/298,524

(22) Filed: Nov. 19, 2002

(51) Int. Cl. F21L 4/02

(52) U.S. Cl. 362/184; 362/194; 362/197; 362/202; 362/205; 362/208; 362/800

(57) ABSTRACT

A flashlight includes a tubular body in which an electric power supply is received and a cap is connected to an end of the body and a bulb assembly is received in the cap. The bulb assembly includes a first set of bulb and a second set of bulb. The first set of bulb has a first plate and the second set of bulb has a second plate, both of the two plates are connected to a negative end An optional member is rotatably connected to an outside of the cap and connected to the first plate and the second plate so that the first set of bulb and the second set of bulb are switched by rotating the optional member and alternatively in contact with an extension plate connected to a positive end. The user may choose either of the first set of bulb or the second set of bulb by rotating the optional member.

### FIELD OF THE INVENTION

The present invention relates to a flashlight that has two sets of bulbs and rotatably contact with a positive plate by operating an optional member so as to provide different features of illumination.

### BACKGROUND OF THE INVENTION

A conventional flashlight 10 is shown in FIG. 1 and generally includes a body 11 in which batteries 15 via an open end 14 of the body 11. A bulb 17 and reflection hood assembly 16 is engaged with the open end 14 and the batteries 15 are in contact between a positive end on a rear end of the assembly 16 and a negative end located at an inside of the body 11 in a form of a spring. A cap 13 is threadedly connected to the open end 14 by engaging with the threads 12 on an outer periphery of the open end 14. The bulb 17 lights up or is turned off when the a control mechanism is operated. The single bulb 17 can only provide a certain type of illumination feature and is not satisfied by the users.

The present invention intends to provide a flashlight that includes two sets of bulbs which are rotatably received in the cap and can be rotatably positioned and operated by rotating an optical member so as to provide desired illumination features by choosing the bulbs.

### SUMMARY OF THE INVENTION

In accordance with one aspect of the present invention, there is provided a flashlight which comprises a tubular body and an electric power supply is received in the body and in contact with a positive end and a negative end. A switch is electrically connected to the positive end and the negative end.

A cap is connected to an end of the body and a bulb assembly is received in the cap. The bulb assembly including a first set of bulb and a second set of bulb, wherein the first set of bulb has a first plate and the second set of bulb has a second plate. Both of the first plate and the second plate are respectively connected to the negative end.

An optional member is rotatably connected to an outside of the cap and connected to the first plate and the second plate. The first set of bulb and the second set of bulb are switched by rotating the optional member and alternatively in contact with an extension plate connected to the positive end.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is an exploded view to show a conventional flashlight;

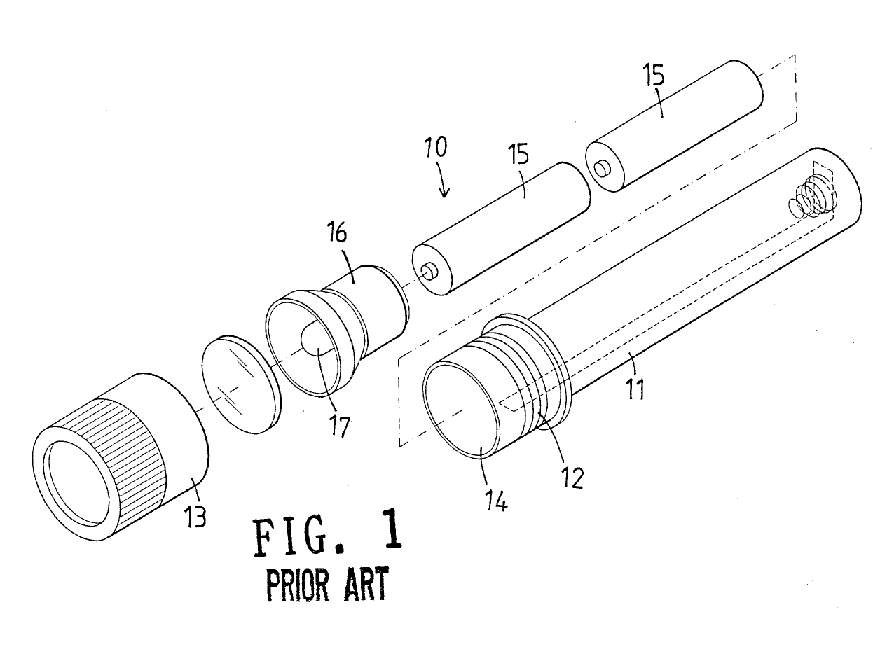

FIG. 2 is an exploded view to show the two sets of bulb and the cap of the flashlight of the present invention;

FIG. 3 is a side cross sectional view to show the flashlight of the present invention;

FIG. 4 shows two cross sectional views of the two sets of bulb and the optional member of the flashlight of the present invention;

FIG. 5 shows the two sets of bulb are switched by rotating the optional member;

FIG. 6 shows circuit for operating the flashlight of the present invention, and

FIG. 7 is a perspective view to show the flashlight of the present invention.

### DETAILED DESCRIPTION OF THE PREFERRED EMBODIMENT

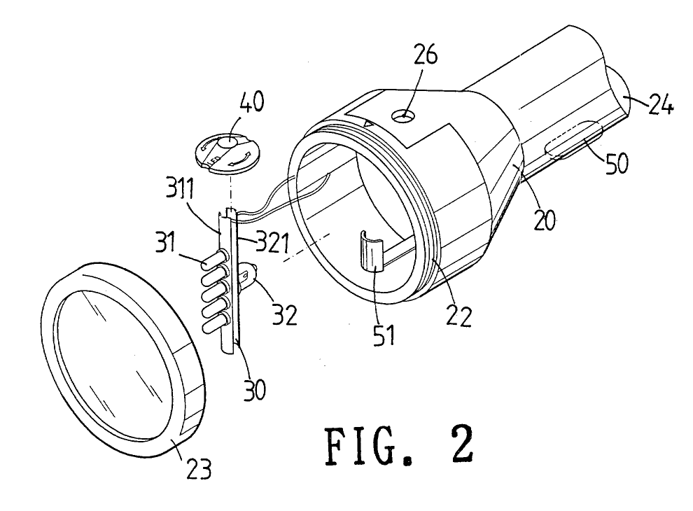

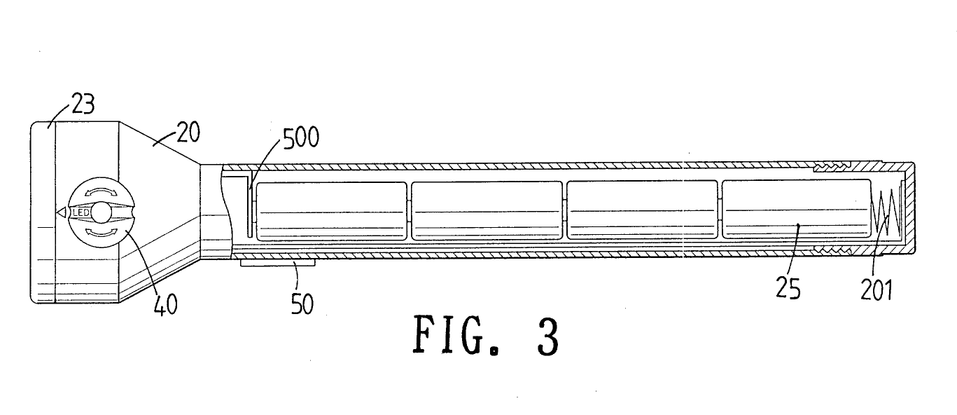

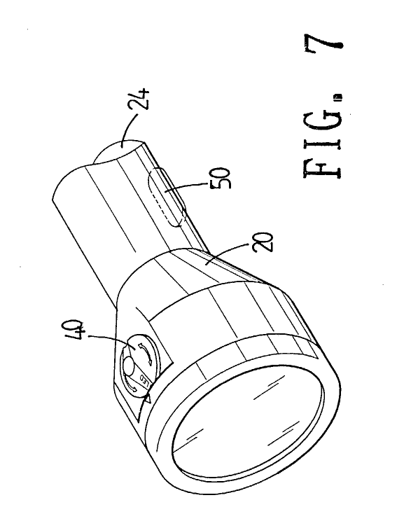

Referring to FIGS. 2, 3, 4, 6 and 7, the flashlight of the present invention comprises a tubular body 24 and an electric power supply such as batteries 25 is received in the body 24. The electric power supply 25 IS in contact with a positive end 500 located at a front end of the body 42 and a negative end 201 which is a spring and located at an inside of rear end of the body 24. A switch 50 is electrically connected to the positive end 500 and the negative end 201.

A cap 20 is connected to the front end of the body 24 and a bulb assembly 30 is received in the cap 20. The bulb assembly 30 includes a first set of bulb 31 and a second set of bulb 32. The first set of bulb 31 has a first plate 311 which is a curved elongated plate. The second set of bulb 32 has a second plate 321 which is a curved elongated plate. The first plate 311 and the second plate 321 are respectively connected to the negative end 201. The first set of bulb 31 includes a plurality of LEDs and the second set of bulb 32 includes a bulb as used in conventional flashlights. A lens is engaged with a collar 23 which is threadedly mounted to the threaded outer periphery 22 on the cap 20.

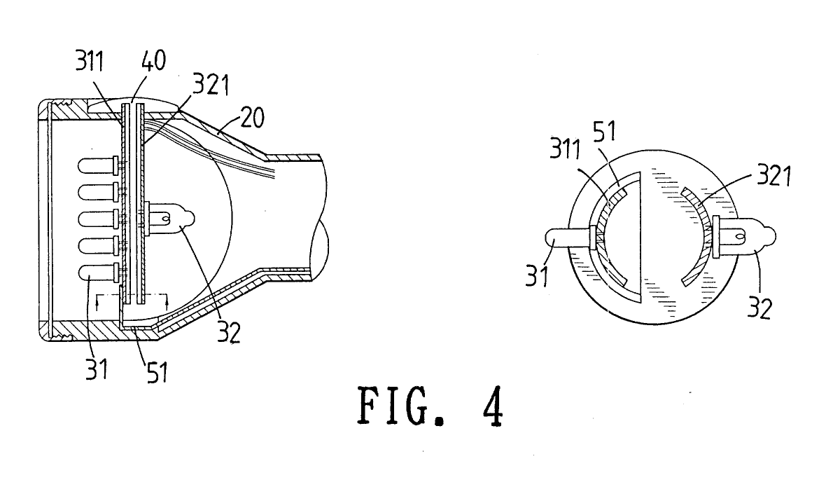

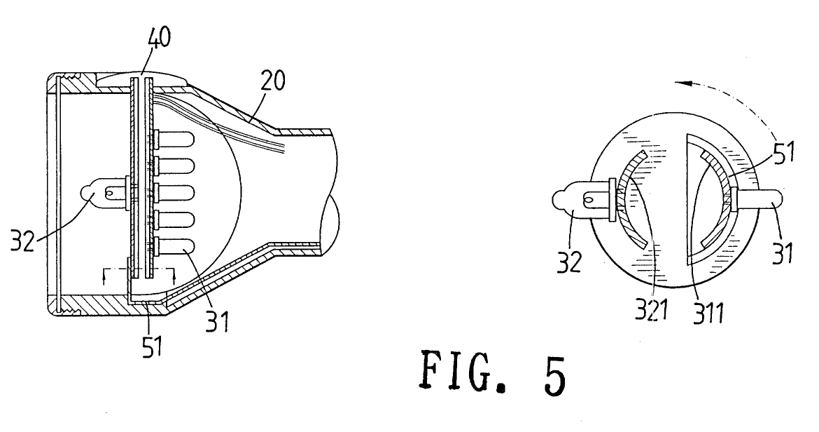

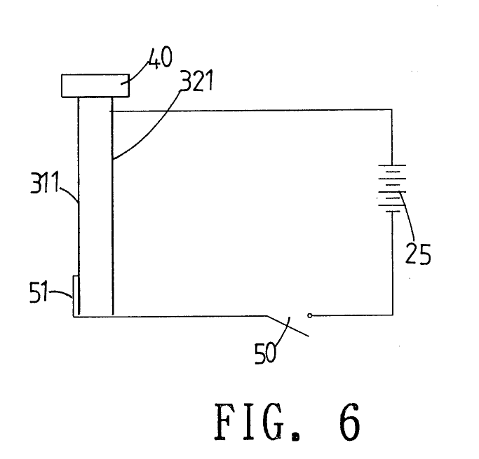

An optional member 40 is rotatably connected to an outside of the cap 20 and connected to the first plate 311 and the second plate 321 via a hole 26 defined through a wall of the cap 20. As shown in FIGS. 4 and 5, the first set of bulb 31 and the second set of bulb 32 are switched by rotating the optional member 40 and the first plate 311 and the second plate 321 are alternatively in contact with an extension plate 51 connected to the positive end 500. As shown in FIG. 6, when the switch 50 is pushed first time, the circuit is on and the first set of bulb 31 or the second set of bulb 32 light up. The first set of bulb 31 and the second set of bulb 32 can be chose by rotating the optional member 40. When the switch 50 is pushed again, the circuit is opened.

While we have shown and described the embodiment in accordance with the present invention, it should be clear to those skilled in the art that further embodiments may be made without departing from the scope of the present invention.

What is claimed is:

1. A flashlight comprising:
a tubular body and an electric power supply received in the body, the electric power supply being in contact with a positive end and a negative end, a switch electrically connected to the positive end and the negative end;
a cap connected to an end of the body and a bulb assembly received in the cap, the bulb assembly including a first set of bulb and a second set of bulb, the first set of bulb having a first plate and the second set of bulb having a second plate, the first plate and the second plate respectively connected to the negative end, and
an optional member rotatably connected to an outside of the cap and connected to the first plate and the second plate so that the first set of bulb and the second set of bulb being switched by rotating the optional member and alternatively in contact with an extension plate connected to the positive end.

2. The flashlight as claimed in claim 1, wherein the first set of bulb includes a plurality of LEDs.

3. The flashlight as claimed in claim 1, wherein the second set of bulb includes a bulb.

4. The flashlight as claimed in claim 1, wherein the first plate and the second plate each are a curved elongated plate.
